(19) United States
(12) Patent Application Publication
(10) Pub. No.: US 2009/0168073 A1
(43) Pub. Date: Jul. 2, 2009

(54) CANTILEVER SENSOR SYSTEM AND PROFILERS AND BIOSENSORS USING THE SAME

(75) Inventors: HUNG-MING TAI, Hsinchu City (TW); JIN-LIANG CHEN, Hsinchu City (TW); YONG-TONG ZOU, Taoyuan County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/167,647

(22) Filed: Jul. 3, 2008

(30) Foreign Application Priority Data
Dec. 28, 2007 (TW) 096150742

(51) Int. Cl. G01B 11/02

(52) U.S. Cl. 356/501; 356/511

(57) ABSTRACT

The present invention relates to a cantilever sensor system and profilers as well as biosensors using the same. The cantilever sensor system comprises: an interferometric lens module; a cantilever module; and an imaging device. The interferometric lens module further comprises: a light source; a light splitting unit; and an interferometric lens; wherein a light beam emitted from the light source is projected to the cantilever module through the light splitting unit and the interferometric lens where it is reflected back to the light splitting unit so as to interfere with the reference light beam from the reference mirror. The imaging device is used for capturing interferograms caused by the interference between the light beam of the light source and the reflected beam thereof. The aforesaid system is able to monitor the cantilever module and other objects in the neighborhood of the same simultaneously, and thus detecting the deflection of the cantilever module, which is easy and convenient to be adapted for profilers and biosensors.

### FIELD OF THE INVENTION

The present invention relates to a cantilever sensor system and profilers as well as biosensors using the same.

### BACKGROUND OF THE INVENTION

Cantilever sensor has many applications, including probe profilers, biosensors and so on. The probe profiler is a device capable of offering detailed surface characterization of a microstructure by detecting the deflection of a flexible cantilever during the contacting of the cantilever with a workpiece. The biosensor also utilizes the low rigidity of a flexible cantilever to perform a biological analysis as the absorption of a specific chemical substance in the flexible cantilever is going to cause certain structural mechanics variation. Please refer to FIG. 1, which shows a conventional cantilever structure adapted for an optical lever method of deflection detection. In FIG. 1, the laser beam L1 emitted from the laser source 1 is projected on the cantilever sensor 2 where it is reflected into a reflected laser beam L2 to be sensed by the location sensing optoelectronic diode 3. As the cantilever sensor is featuring by its high sensitivity and high reliability, it is vastly adapted and applied in semiconductor industry, precision machinery industry, micro-electro-mechanical system, and fields of nano technology.

With the rapid advance of technology, there is a growing need required for an operator to observe and monitor an operating cantilever sensor and other objects in the neighborhood of the same simultaneously for facilitating the operator to locate his/her target object. Accordingly, there are more and more studies focusing on the use of cantilever sensor array in probe profilers and biosensors. Although there are already a handful of product adopted such studies, but there are still problems remained unsolved. First of which is that the arranging of a cantilever module, a optical lever module and an imaging in a system is going to take up a conceivable space, not to mention that not only the aforesaid modules are difficult to integrated, but also the laser alignment procedure in the optical lever module can be very complex. Second of which is that the conventional optical lever method usually pair one laser optical lever module with one cantilever module, that is, they are one-to-one related, so that the conventional optical lever method is not suitable for the development of profilers or biosensors using probe array.

In the atomic force microscopes disclosed in U.S. Pat. No. 5,861,624, entitled “Atomic force microscope for attachment to optical microscope” and U.S. Pat. No. 5,952,657, entitled “Atomic force microscope with integrated optics for attachment to optical microscope”, its cantilever probe module is designed to be incorporated into or attachable to an objective lens of its optical microscope at a position beneath thereof such that a cantilever deflection can be detected by the use of the optical lever method.

In the biosensor system disclosed in U.S. Pub. No. 20020092340, entitled “Cantilever array sensor system”, the cantilever deflection is also being detected by the use of the optical lever method. However, it is designed with a complex optical path system for not only focusing laser beam upon its cantilever array sensor, but also for enabling all the reflected laser beam to be conceived by its photo detector in respective.

In the atomic force microscopes disclosed in U.S. Pat. No. 5,689,063, entitled “Atomic force microscope using cantilever attached to optical microscope”, its cantilever probe module is designed to be attachable to an objective lens of its optical microscope, but it is characterized in that: the cantilever sensor used should be a specialized multiplayer piezoelectric cantilever.

### SUMMARY OF THE INVENTION

The object of the present invention is to provide a cantilever sensor system, capable of being adapted for profilers and biosensors in an easy and convenient manner.

In an exemplary embodiment, the present invention provides a cantilever sensor system, which is comprised of: an interferometric lens module, further comprising a light source, a light splitting unit, and an interferometric lens; a cantilever module; and an imaging device; wherein a light beam emitted from the light source is projected to the cantilever module through the light splitting unit and the interferometric lens where it is reflected for enabling the same to interfere with a reference light beam and thus enabling the imaging device to capture an interferogram caused by the interference.

In another exemplary embodiment, the present invention provides a profiler with cantilever sensor system, which is comprises of: an interferometric lens module, further comprising a light source, a light splitting unit, and an interferometric lens; a cantilever module, being configured with at least cantilever attached with a probe in a manner that it is capable of scanning a surface profile of a sample by the probe; an imaging device; an image processing unit; and a sample stage, being arranged at a position beneath the cantilever module and used for carrying the sample; wherein a light beam emitted from the light source is projected to the cantilever module through the light splitting unit and the interferometric lens where it is reflected for enabling the same to interfere with a reference light beam, thereby, when the probe is used for scanning the sample's surface and thus deflected corresponding to the continuing profile variation of the surface, a serial of continuing interferograms are generated and captured by the imaging device and then being send to the image processing unit for processing.

In further another exemplary embodiment, the present invention provides a biosensor with cantilever sensor system, which is comprises of: a cavity, for storing a chemical substance therein; an interferometric lens module, further comprising a light source, a light splitting unit, and an interferometric lens; a cantilever module, being configured with at least cantilever attached with a corresponding chemical substance capable of reacting to the chemical substance stored in the cavity; an imaging device; and an image processing unit; wherein a light beam emitted from the light source is projected to the cantilever module through the light splitting unit and the interferometric lens where it is reflected for enabling the same to interfere with a reference light beam, thereby, when the probe is deflected by a chemical reaction between the two chemical substances, a serial of interferograms corresponding to the continuing chemical reaction are generated and captured by the imaging device and then being send to the image processing unit for processing.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a conventional cantilever structure adapted for an optical lever method of deflection detection.

FIG. 2 is a schematic view of a cantilever sensor system according to an exemplary embodiment of the invention.

FIG. 3 is a top view of an interferogram caused by a single cantilever in the cantilever sensor system of the invention.

FIG. 4 is a top view of an interferogram caused by an array of cantilevers in the cantilever sensor system of the invention.

FIG. 5 shows two interference fringes formed on a cantilever of the invention.

FIG. 6 is a side view of the cantilever of FIG. 5.

FIG. 7 is a schematic diagram depicting the light intensity projected upon the cantilever of FIG. 5.

FIG. 8 is a schematic view of a profile with cantilever sensor system according to an exemplary embodiment of the invention.

FIG. 9 is a schematic view of a profile with cantilever sensor system according to another exemplary embodiment of the invention.

FIG. 10 is a schematic view of a biosensor with cantilever sensor system according to an exemplary embodiment of the invention.

FIG. 11 is a schematic view of a biosensor with cantilever sensor system according to another exemplary embodiment of the invention.

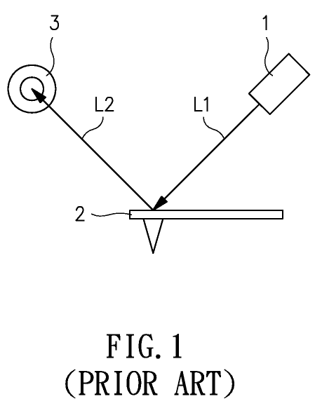

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

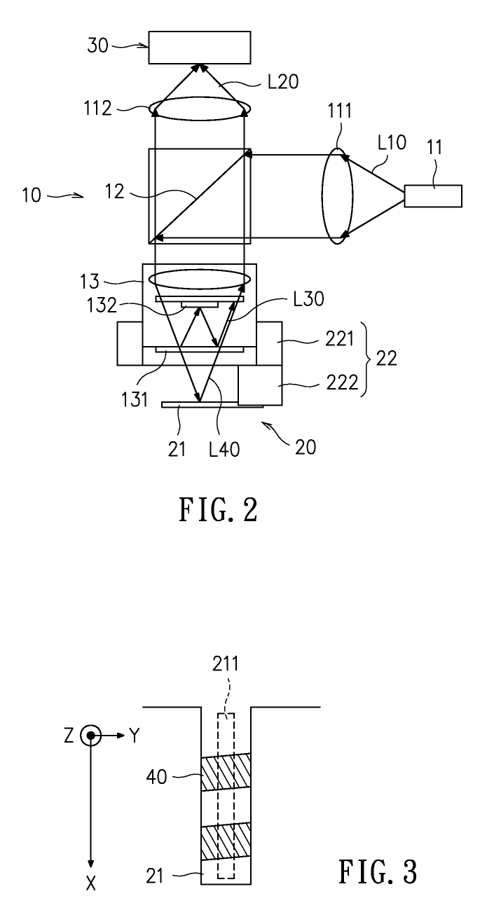

Please refer to FIG. 2, which is a schematic view of a cantilever sensor system according to an exemplary embodiment of the invention. The cantilever sensor system of FIG. 2 comprises: an interferometric lens module 10, a cantilever module 20 and an imaging device 30; in which the interferometric lens module 10 further comprises: a light source 11, a light splitting unit 12, and an interferometric lens 13. The light source 11 can be a laser source or a low coherence light source that is used for emitting a light beam L10. The light splitting unit 12 can be a beam splitter that is used for guiding and directing the traveling of the light beam L10. The interferometric lens 13 can be a lens selected from the group consisting of a Mirau-type interferometric objective lens, a Michelson-type interferometric objective lens, and a Linnik-type interferometric objective lens. In this exemplary embodiment, a Mirau-type interferometric objective lens is used for illustration which is primary composed of a reference light splitter 131 and a standard light reflector 132. The cantilever module 20 in this embodiment is composed of one cantilever 21, however, there can be an array of cantilever being formed in the cantilever module 20. In FIG. 2, the cantilever module 20 is attached to the bottom of the interferometric lens module 10 by a connection module 22, which includes a connector 221 and a micro adjusting device 222. That is, by the connection of the connector 221, the micro adjusting device 222 and the cantilever module 20 are attached to the bottom of the interferometric lens module 10 in a manner that the micro adjusting device 222 can be used for precisely fine tuning a distance between the cantilever 21 and the interferometric lens 13. The micro adjusting device 222 is usually able to adjust a position in a direction defined by an X-axis, a Y-axis and a Z-axis of a Cartesian coordinate system as well as the angle defined by the same Cartesian coordinate system. Moreover, the imaging device 30 that is used for capturing images can be a CCD image sensor or a CMOS image sensor.

The following description relates to how the beam L10 is transformed into the beam L20. After the beam L10 emitted from the light source 11 is enlarged by the lens 111, it is projected to the light splitting unit 12 where it is reflected to form a reflected beam traveling toward the interferometric lens 13. In the interferometric lens 13, the reflected beam is split by the reference light splitter 131 for enabling a portion of the reflected beam to project on the cantilever 21 where it is reflected to form another reflected beam L40, while enabling the rest of the reflected beam to be reflected by the reference light splitter 131 and thus shine toward the standard reflector 132 where it is reflected to the reference light splitter 131 for another reflection so as to form a reference beam L30 that travels passing the light splitting unit 12. By the interference between the reflected beam L40 and the reference beam L30, an interferometric beam L20 is generated. After the interferometric beam L20 is focused by a lens 112, an interferogram caused by the interferometric beam L20 can be captured by the imaging device 30.

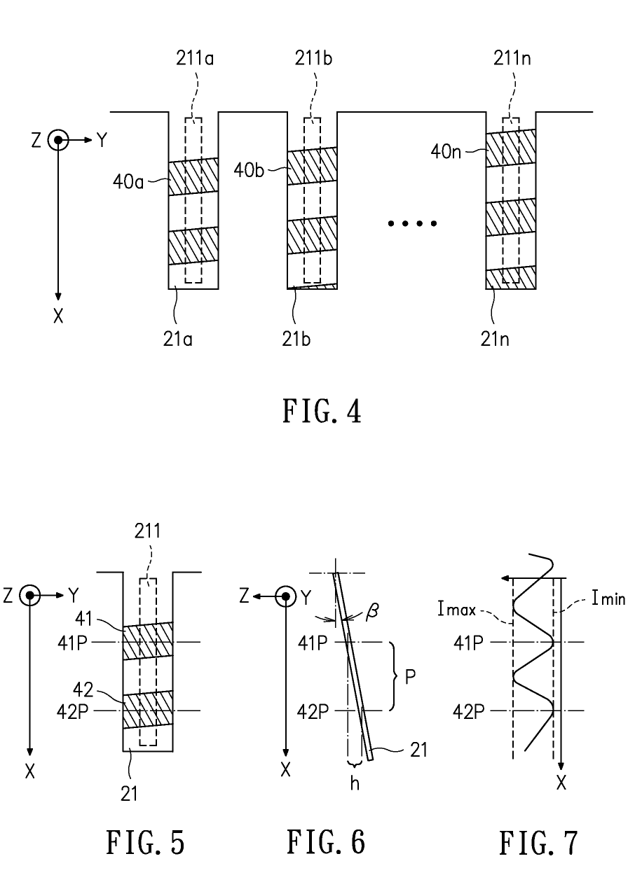

FIG. 3 is a top view of an interferogram caused by a single cantilever in the cantilever sensor system of the invention. By the cantilever sensor system of FIG. 2, interference fringes 40 can be formed on the cantilever 21 which can be captured by the imaging device 30. As for the imaging range of the imaging device 21, it can be an imaging zone 211 covering only a portion of the cantilever 21, as shown in FIG. 3. The imaging device 30 should be able to detect the horizontal movement of the interference fringes 40 on the cantilever 21; or should be able to detect the light intensity variation at a specific location of the cantilever 21. Please refer to FIG. 4, which is a top view of an interferogram caused by an array of cantilevers in the cantilever sensor system of the invention. As shown in FIG. 4, there can be interference fringes 40a, 40b, . . . , 40n, being formed respectively on the array of cantilevers 21a, 21b, , . . . , 21n simultaneously that can be imaged by the imaging device 30 at the same time. The imaging device 30 is quite capable of processing the portions of those interference fringes 40a, 40b, . . . , 40n in their respective imaging zones 211a, 211b, . . . , 211n in an one-by-one or simultaneous manner without the help of any additional optical lever module or cantilever module. In addition, As the depth of field of the interferometric lens 13 can reach 50 μm, it is capable of monitoring the cantilever and other objects in the neighborhood of the same simultaneously, and thus detecting the deflection of the cantilever.

Please refer to FIG. 5 and FIG. 6, in which FIG. 5 shows two interference fringes 41, 42 formed on a cantilever 21 of the invention and FIG. 6 is a side view of the cantilever 21 of FIG. 5. As the cantilever 21 is slanted, the vertical throw h of the centers 41P, 42P of the two neighboring interference fringes 41, 42 is λ/2, where λ is the wavelength of the light L10 emitted from the light source of FIG. 2; and the fringe pitch P of the two neighboring interference fringes 41, 42 is about λ/[ sin(β)], where β is the horizontal inclination angle of the cantilever 21. Since h=λ/2, the fringe pitch P is equal to h/sin(β)=λ/[2 sin(β)]. For instance, when λ=532 nm and the horizontal inclination angle is 13 degrees, the fringe pitch P=(532/2)/sin 13°=633.33 (nm).

Please refer to FIG. 5 to FIG. 7, in which FIG. 7 is a schematic diagram depicting the light intensity projected upon the cantilever of FIG. 5. By the fringe pitch P defining above that P=h/sin(β)=λ/[2 sin(β)], the resolution of the imaging device 30 of FIG. 2 required for detecting the horizontal movement of the interference fringes 40 on the cantilever 21 can be determined. Taking the single cantilever 21 for example, only those electric signals corresponding to the pixels arranged along a straight line in the image zone 211 should be sufficient. For example, if there are m*n pixels in the image zone 211, the detection resolution of the cantilever should be P/m, and when λ=532 nm, the horizontal inclination angle is 13 degrees and m=256, the resolution P/m=(532/[2×sin (13°)]/256=(563/[2×0.2250])=4.62 (nm).

Similarly, by the fringe pitch P defining above that P=h/sin(β)=λ/[2 sin(β)], the imaging device 30 is able to detect the variation of light intensity at a specific location on the cantilever 21 can be detected by. Also taking the single cantilever 21 for example, only those electric signals corresponding to the pixels arranged along a straight line in the image zone 211 are taken in a manner that the maximum light intensity Imax and the minimum light intensity Imin are registered so as to select the locations of the cantilever whose light intensities are about equal to (Imax+Imin)/2 to be used as the basis for monitoring the deflection of the cantilever 21. If the gray level difference bits between the Imax and the Imin is g, the resolution of the cantilever deflection detection is approximated by h/(2g). For instance, when λ=532 nm and g=128 bits, the approximate resolution of the cantilever deflection detection is h/(2g)=(λ/2)/(2*128)=(532/2)/(2*128)=1.04 (nm).

By the above method for calculating the resolution, it is noted that the cantilever sensor system of the invention can be used for detecting the horizontal movement of the interference fringes 40 on the cantilever or for detecting the light intensity variation at a specific location of the cantilever, despite that the obtained resolutions might be different slightly.

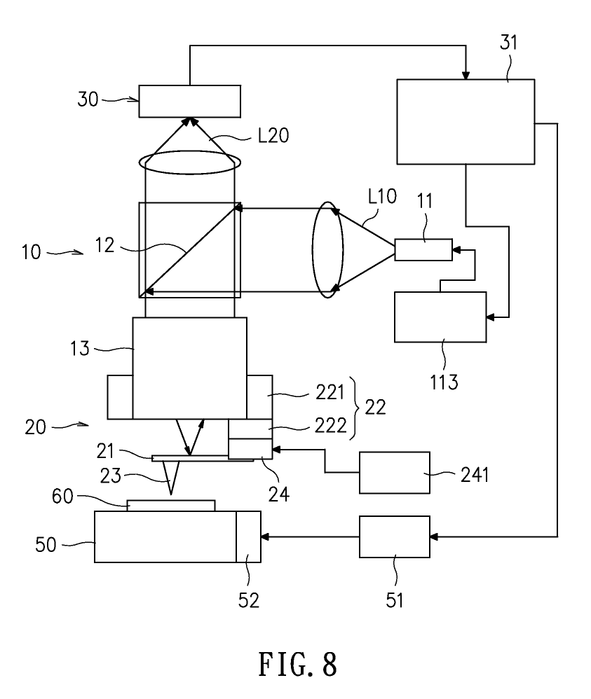

Please refer to FIG. 8, which is a schematic view of a profile with cantilever sensor system according to an exemplary embodiment of the invention. The profiler of FIG. 8 comprises: an interferometric lens module 10, a cantilever module 20 and an imaging device 30, in which the interferometric lens module 10 is further comprised of a light source 11, a light splitting unit 12, and an interferometric lens 13 and the cantilever module 20 is configured with at least a cantilever 21. The above components are all enabled to function similar to those described in the exemplary embodiment shown in FIG. 2, and thus are not described further herein. The present embodiment is characterized in that: there is a sample stage 50 disposed beneath the cantilever module 20 which is usually configured with a motor and a piezoelectric actuator and is used for carrying a sample 60 for profile scanning, and as the present invention is used for profile scanning, there is a probe 23 arranged at the bottom of the cantilever 21 for probing the surface profile of the sample 60. In addition, the imaging device 30 is further connected to an image processing unit 31 for processing the interferograms captured by the imaging device 30, that the image processing unit 31 is electrically connected to a light source driver 113 and a sample stage driver 51.

When the abovementioned profiler is operating, the probe 23 of the cantilever 21 will scan along the surface of the sample 60 for enabling the probe 23 to move up and down by the undulation of the sample's surface. When the cantilever 21 is pushed by the surface and thus raised as the status shown in FIG. 6, the interference fringes on the cantilever 21 appear to be floating so that the image processing unit 31 will issue a command for directing the sample stage driver 51 to lower the sample stage 50 and thus separating the probe 23 from the pushing of the sample 60. By separating the probe 23 from the sample 60, the cantilever 21 is released and restored back to its original status while stabilizing the interference fringes. Thereby, a close-circuit feedback control system can be established. In an exemplary embodiment of the invention, the sample stage 50 can be configured with a micro adjusting device 52, which is used for precisely fine tuning the position of the sample stage 50. Moreover, as the micro adjusting device 52 is enabled to adjust a position in a direction defined by an X-axis, a Y-axis and a Z-axis of a Cartesian coordinate system as well as the angle defined by the same Cartesian coordinate system, that it can work cooperatively with the micro adjusting device 222 of the cantilever 21 for positioning the sample 60 at the optimal location and distance with reference to the cantilever 21.

Furthermore, for lowering noise interference and enhancing detection sensitivity, an improved oscillation profiler utilizing oscillating detection can be adopted. As shown in FIG. 8, the cantilever module 20 includes an oscillator 24 which can be piezoelectric actuator capable of being driven to vibrate by a driver 241 in a manner that the cantilever 21 is brought along to vibrate and thus cause the vibration frequency as well as the vibration amplitude of the interference fringes to vary accordingly. The image processing unit 31 is therefore being enabled to perform a frequency/amplitude analysis by the use of a lock-in amplifier or a software.

As the light source can be a laser source or a low coherence light source that in this exemplary embodiment, a low coherence light source is adopted since when the coherence length is smaller than the height of the probe where it is located, the interference fringes will only appear on the cantilever so that an image of the sample without the interferogram can be acquired. In addition, for compensating the affection of the ambient temperature upon the sensor, the cantilever module is configured with a plurality of cantilevers 21, in which at least one of the plural cantilevers 21 is a tipless cantilever to be used as a reference cantilever for calibrating the other cantilevers since it is incapable of contacting with the sample 60 while the others did.

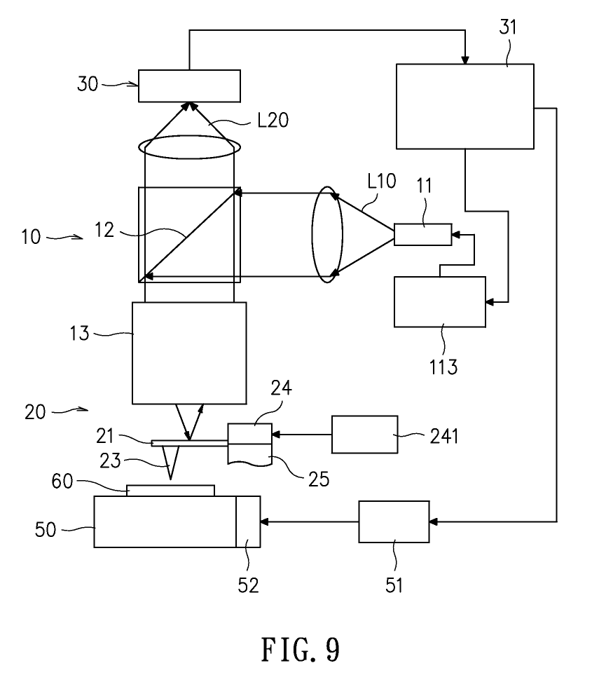

Please refer to FIG. 9, which is a schematic view of a profile with cantilever sensor system according to another exemplary embodiment of the invention. The present embodiment has components capable of functioning similar to those disclosed in FIG. 8 and thus are numbered as such. The difference between the two is that: in this embodiment, the cantilever module 20 is arranged separately from the interferometric lens module 10 in a manner that its cantilever 21 is mounted on a cantilever base 25, as shown in FIG. 9. It is noted that the cantilever base 25 can be arranged at any location at will only if it can firmly support the cantilever 21. In addition, the cantilever base 25 can be configured with a micro adjusting device for precisely fine tuning the position of the cantilever 21. In this embodiment, the height variation of the cantilever can be obtained from the total phase variation of a series of the floating continue interferograms by using the method described in FIG. 6 to FIG. 8.

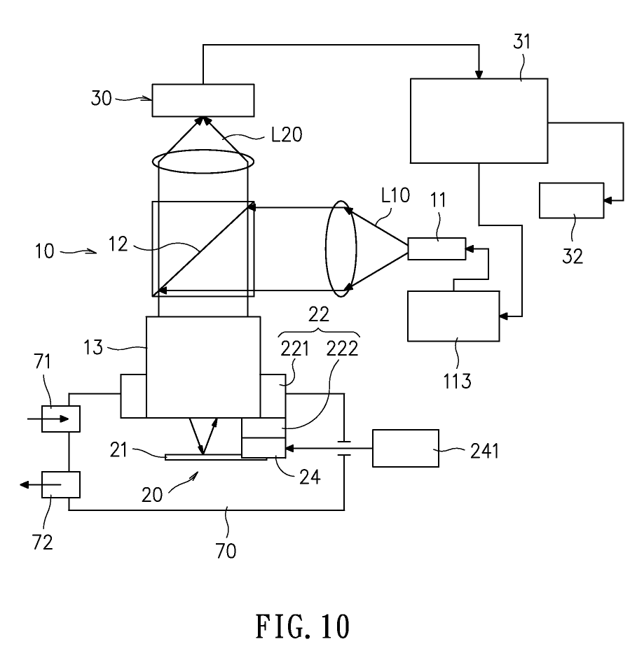

Please refer to FIG. 10, which is a schematic view of a biosensor with cantilever sensor system according to an exemplary embodiment of the invention. The biosensor comprises: an interferometric lens module 10, a cantilever module 20 and an imaging device 30, in which the interferometric lens module 10 is further comprised of a light source 11, a light splitting unit 12, and an interferometric lens 13 and the cantilever module 20 is configured with at least a cantilever 21. The above components are all enabled to function similar to those described in the embodiment shown in FIG. 2 and thus are not described further herein. The present embodiment is characterized in that: the cantilever module 20 is received inside a cavity 70, which includes an inlet 71 and an outlet 72. The inlet 71 is used for a chemical substance to be fed into the cavity therethrough, and the outlet 72 is used for the chemical substance to flow out the cavity therethrough. Moreover, the surface of the cantilever 21 is coated or electroplated with a corresponding chemical substance capable of reacting to the chemical substance stored in the cavity 70 and thus cause the cantilever 21 to deform. By draining the chemical substance from the cavity 70 through the outlet 72, another chemical substance can be fed into the cavity 70. In addition, the imaging device can be connected to more than one image processing unit 31 while connecting each image processing unit 31 simultaneously to an output device 32. It is noted that the output device can be a monitor, a speaker, or other audio/video apparatuses. When the imaging device 30 captures the interferogram caused by the deformation of the cantilever 21 and then send the captured image to the image processing unit 31 where it is processed, the image processing unit 31 will issue a signal to inform the output device 32 for directing the output device to issue an alerting signal as reminder.

Similar to that show in FIG. 8, for lowering noise interference and enhancing detection sensitivity, the cantilever module 20 includes an oscillator 24 which can be piezoelectric actuator capable of being driven to vibrate by a driver 241 in a manner that the cantilever 21 is brought along to vibrate and thus cause the vibration frequency as well as the vibration amplitude of the interference fringes to vary accordingly. The image processing unit 31 is therefore being enabled to perform a frequency/amplitude analysis by the use of a lock-in amplifier or a software.

In addition, for compensating the affection of the ambient temperature upon the sensor, the cantilever module is configured with a plurality of cantilevers 21, in which at least one of the plural cantilevers 21 is not attached by its corresponding chemical substance so as to be used as a reference cantilever for calibrating the other cantilevers since it is incapable of reacting with the chemical substance of the cavity while the others did.

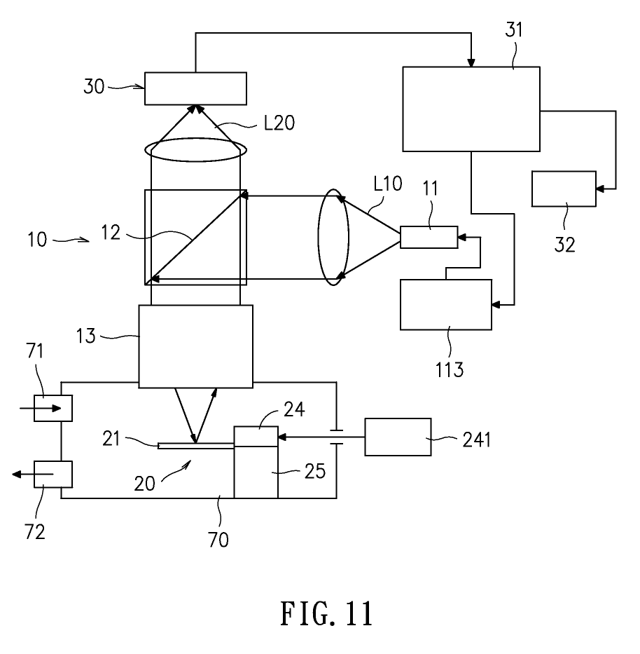

Please refer to FIG. 11, which is a schematic view of a biosensor with cantilever sensor system according to another exemplary embodiment of the invention. The present embodiment has components capable of functioning similar to those disclosed in FIG. 10 and thus are numbered as such. The difference between the two is that: in this embodiment, the cantilever module 20 is arranged separately from the interferometric lens module 10 in a manner that its cantilever 21 is mounted on a cantilever base 25. It is noted that the cantilever base 25 can be arranged at any location at will and can be formed in any formation, only if it can firmly support the cantilever 21, e.g. it is received inside the cavity 70 as shown in FIG. 9. In addition, the cantilever base 25 can be configured with a micro adjusting device for precisely fine tuning the position of the cantilever 21.

To sum up, the present invention provides a cantilever sensor system capable of monitoring the cantilever module and other objects in the neighborhood of the same simultaneously based upon the microscopic viewing of interferograms, by which not only the bulky optical lever module in the conventional cantilever can be avoided, but also by integrating the cantilever sensor with its imaging device only a portion of the image captured by the imaging device is required to be processed. In addition, as the single cantilever can be replaced by an array of cantilever for increase the amount of cantilever in the cantilever module, there is no need to configured additional optical cantilever module or other optic sensor into the whole cantilever sensor system for detection the deflection of each cantilever since each cantilever in the array can be imaged as a portion of the image captured by the imaging device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A cantilever sensor system, comprising:
a cantilever module, configured with at least a cantilever;
an interferometric lens module, further configured with a light source, a light splitting unit, and an interferometric lens in a manner that a light beam emitted from the light source is projected to the at least one cantilever through the light splitting unit and the interferometric lens where it is reflected back to the light splitting unit for forming interference fringes accordingly; and
an imaging device, for capturing an interferogram of the interference fringes.

2. The cantilever sensor system of claim 1, wherein the cantilever module is configured with a plurality of cantilevers.

3. The cantilever sensor system of claim 1, wherein the cantilever module is attached to the bottom of the interferometric lens module.

4. The cantilever sensor system of claim 3, wherein the cantilever module is attached to the bottom of the interferometric lens module by a micro adjusting device for precisely fine tuning a distance between the cantilever and the interferometric lens.

5. The cantilever sensor system of claim 4, wherein the micro adjusting device is enabled to adjust a position in a direction defined by an X-axis, a Y-axis and a Z-axis of a Cartesian coordinate system as well as the angle defined by the same Cartesian coordinate system.

6. The cantilever sensor system of claim 1, wherein the cantilever module is arranged separately from the interferometric lens module in a manner that it is mounted on a cantilever base.

7. The cantilever sensor system of claim 6, wherein the cantilever base is configured with a micro adjusting device for precisely fine tuning the positioning of the cantilever.

8. The cantilever sensor system of claim 7, wherein the micro adjusting device is enabled to adjust a position in a direction defined by an X-axis, a Y-axis and a Z-axis of a Cartesian coordinate system as well as the angle defined by the same Cartesian coordinate system.

9. The cantilever sensor system of claim 1, wherein the light source is a source selected form the group consisting of a laser source and a low coherence light source.

10. The cantilever sensor system of claim 1, wherein the light source is driven to illuminate by a driver.

11. The cantilever sensor system of claim 1, wherein the interferometric lens is a lens selected from the group consisting of a Mirau-type interferometric objective lens, a Michelson-type interferometric objective lens, and a Linnik-type interferometric objective lens.

12. A profile with cantilever sensor system, comprising:
a cantilever module, being configured with at least cantilever attached with a probe;
a sample stage, being arranged at a position beneath the cantilever module and used for carrying a sample intended for profile scanning;
an interferometric lens module, further configured with a light source, a light splitting unit, and an interferometric lens in a manner that a light beam emitted from the light source is projected to the at least one cantilever through the light splitting unit and the interferometric lens where it is reflected back to the light splitting unit for forming interference fringes accordingly;
an imaging device, for capturing an interferogram of the interference fringes; and
an image processing unit, for processing the interferogram.

13. The profile of claim 12, wherein the cantilever module further comprises:
an oscillator, for exciting the cantilever module to vibrate and thus causing the vibration frequency and the amplitude of the interferogram to change accordingly.

14. The profile of claim 13, wherein the oscillator is a piezoelectric actuator.

15. The profile of claim 13, wherein the oscillator is driven to vibrate by a driver.

16. The profile of claim 13, wherein the image processing unit is enabled to perform a frequency/amplitude analysis by the use of a means selected from the group consisting of: a lock-in amplifier and a software.

17. The profile of claim 12, wherein the cantilever module is configured with a plurality of cantilevers, in which at least one of the plural cantilevers is a tipless cantilever to be used as a reference cantilever for calibrating the other cantilevers since it is incapable of contacting with the sample while the others did.

18. The profile of claim 12, wherein the cantilever module is attached to the bottom of the interferometric lens module.

19. The profile of claim 18, wherein the cantilever module is attached to the bottom of the interferometric lens module by a micro adjusting device for precisely fine tuning a distance between the cantilever and the interferometric lens.

20. The profile of claim 19, wherein the micro adjusting device is enabled to adjust a position in a direction defined by an X-axis, a Y-axis and a Z-axis of a Cartesian coordinate system as well as the angle defined by the same Cartesian coordinate system.

21. The profile of claim 12, wherein the cantilever module is arranged separately from the interferometric lens module in a manner that it is mounted on a cantilever base.

22. The profile of claim 21, wherein the cantilever base is configured with a micro adjusting device for precisely fine tuning the positioning of the cantilever.

23. The profile of claim 22, wherein the micro adjusting device is enabled to adjust the position in a direction defined by an X-axis, a Y-axis and a Z-axis of a Cartesian coordinate system as well as the angle defined by the same Cartesian coordinate system.

24. The profile of claim 12, wherein the sample stage is further configured with a micro adjusting device for precisely fine tuning the position of the sample stage.

25. The profile of claim 24, wherein the micro adjusting device is enabled to adjust a position in a direction defined by an X-axis, a Y-axis and a Z-axis of a Cartesian coordinate system as well as the angle defined by the same Cartesian coordinate system.

26. The profile of claim 12, wherein the light source is a source selected form the group consisting of a laser source and a low coherence light source.

27. The profile of claim 12, wherein the light source is driven to illuminate by a driver.

28. The profile of claim 12, wherein the interferometric lens is a lens selected from the group consisting of a Mirau-type interferometric objective lens, a Michelson-type interferometric objective lens, and a Linnik-type interferometric objective lens.

29. A biosensor with cantilever sensor system, comprising:
a cavity, for storing a chemical substance therein;
a cantilever module, being received inside the cavity and configured with at least cantilever, each being attached with a corresponding chemical substance capable of reacting to the chemical substance stored in the cavity;
an interferometric lens module, further comprising a light source, a light splitting unit, and an interferometric lens in a manner that a light beam emitted from the light source is projected to the at least one cantilever through the light splitting unit and the interferometric lens where it is reflected back to the light splitting unit for forming interference fringes accordingly;
an imaging device, for capturing an interferogram of the interference fringes; and
an image processing unit, for processing the interferogram.

30. The biosensor of claim 29, wherein the cavity further comprises:
an inlet, for the chemical substance to be fed into the cavity therethrough; and
an outlet, for the chemical substance to flow out of the cavity therethrough.

31. The biosensor of claim 29, wherein the attaching of the chemical substance is to its corresponding cantilever is performed by a means selected from the group consisting of: coating and electroplating.

32. The biosensor of claim 29, wherein the cantilever module further comprises:
an oscillator, for exciting the cantilever module to vibrate and thus causing the vibration frequency and the amplitude of the interferogram to change accordingly.

33. The biosensor of claim 32, wherein the oscillator is a piezoelectric actuator.

34. The biosensor of claim 32, wherein the oscillator is driven to vibrate by a driver.

35. The biosensor of claim 32, wherein the image processing unit is enabled to perform a frequency/amplitude analysis by the use of a means selected from the group consisting of: a lock-in amplifier and a software.

36. The biosensor of claim 29, wherein the cantilever module is configured with a plurality of cantilevers, in which at least one of the plural cantilevers is not attached by its corresponding chemical substance so as to be used as a reference cantilever for calibrating the other cantilevers since it is incapable of reacting with the chemical substance of the cavity while the others did.

37. The biosensor of claim 29, wherein the cantilever module is attached to the bottom of the interferometric lens module.

38. The biosensor of claim 37, wherein n the cantilever module is attached to the bottom of the interferometric lens module by a micro adjusting device for precisely fine tuning a distance between the cantilever and the interferometric lens.

39. The biosensor of claim 38, wherein the micro adjusting device is enabled to adjust a position in a direction defined by an X-axis, a Y-axis and a Z-axis of a Cartesian coordinate system as well as the angle defined by the same Cartesian coordinate system.

40. The biosensor of claim 29, wherein the cantilever module is arranged separately from the interferometric lens module in a manner that it is mounted on a cantilever base.

41. The biosensor of claim 29, wherein the cantilever base is configured with a micro adjusting device for precisely fine tuning the positioning of the cantilever.

42. The biosensor of claim 41, wherein the micro adjusting device is enabled to adjust a position in a direction defined by an X-axis, a Y-axis and a Z-axis of a Cartesian coordinate system as well as the angle defined by the same Cartesian coordinate system.

43. The biosensor of claim 29, wherein the image processing unit is connected to an output device which is used for outputting status of the cantilever.

44. The biosensor of claim 43, wherein the output device is a device selected from the group consisting of: a monitor, a speaker, and other audio/video apparatuses.

45. The biosensor of claim 29, wherein the light source is a source selected form the group consisting of a laser source and a low coherence light source.

46. The biosensor of claim 29, wherein the light source is driven to illuminate by a driver.

47. The biosensor of claim 29, wherein the interferometric lens is a lens selected from the group consisting of a Mirau-type interferometric objective lens, a Michelson-type interferometric objective lens, and a Linnik-type interferometric objective lens.
